(19) United States
(12) Patent Application Publication
(10) Pub. No.: US 2017/0223017 A1
(43) Pub. Date: Aug. 3, 2017

(54) INTERPRETING USER EXPRESSION BASED ON CAPTURED BIOMETRIC DATA AND PROVIDING SERVICES BASED THEREON

(71) Applicant: MasterCard International Incorporated, Purchase, NY (US)

(72) Inventor: Manoneet Kohli, O'Fallon, MO (US)

(21) Appl. No.: 15/014,627

(22) Filed: Feb. 3, 2016

(51) Int. Cl. H04L 29/06; G06Q 20/40; H04W 12/06

(52) U.S. Cl. CPC H04L 63/0861; H04L 63/0853; H04L 63/18; H04W 12/06; G06Q 20/40145

(57) ABSTRACT

Methods and systems for authenticating a user based on user expression. In some embodiments, an authentication service computer receives a user authentication request during a transaction, determines that the user is enrolled in a user expression authentication service, and transmits a prompt message for biometric data to a user device of the user. The authentication service computer then determines that received biometric data matches stored biometric data associated with the user indicating at least one type of user expression, generates a risk score when the user expression is fear and stress, and transmits a positive user authentication response to an entity computer when the risk score is less than a predetermined threshold value (or when the user expression indicates happiness or confidence). However, a transaction decline message is transmitted to the entity computer when the risk score exceeds the predetermined threshold value.

### FIELD OF THE INVENTION

Embodiments generally relate to systems and methods for interpreting user expression based on biometric data and then providing one or more services based on the interpretation. More particularly, embodiments relate to authenticating a user based on user expression interpreted from biometric data captured during a transaction, and then determining whether or not to provide targeted and/or value added services.

### BACKGROUND OF THE INVENTION

Many modern day transactions involve a user operating a mobile device. For example, a user may utilize her cellphone to purchase an item. A large number of other types of transactions are also known that require user authentication and/or transaction authorization. The user is typically authenticated by entering a personal identification number (“PIN”) or the like. However, it is becoming increasingly important to provide additional types of authentication procedures (which may be referred to as “multi-factor” authentication) for improved security and improved authentication.

Payment card issuers and other financial institutions now offer or use standardized Internet purchase transaction protocols to improve online transaction performance and to accelerate the growth of electronic commerce. Under some standardized protocols, card issuers or issuing banks may authenticate purchase transactions thereby reducing the likelihood of fraud and associated chargebacks attributed to cardholder not-authorized transactions. One example of a standardized protocol is the 3-D Secure Protocol, which leverages existing Secure Sockets layer (SSL) encryption functionality and provides enhanced security through issuer authentication of the cardholder during the online shopping session. The 3-D Secure protocol is consistent with and underlies the authentication programs offered by card issuers (for example, Verified by Visa™ and/or MasterCard® SecureCode™) to authenticate customers for merchants during remote transactions such as those associated with the Internet.

It would be desirable to provide additional types of user authentication and/or transaction authorization techniques utilizing biometric data captured by a user device.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of an example of a transaction system operable for interpreting biometric data captured during a transaction to determine user expression and for determining whether or not to authenticate the user and/or to provide targeted and/or value added services in accordance with an embodiment of the disclosure;

FIG. 2 is a block diagram of an embodiment of a user mobile device illustrating some hardware aspects utilized to authenticate users and/or to provide additional processing in accordance with some embodiments of the disclosure;

FIG. 3 illustrates a user enrollment process in accordance with some embodiments of the disclosure;

FIG. 4 is a flowchart illustrating an entity enrollment process according to some embodiments of the disclosure;

FIGS. 5A and 5B form a flowchart illustrating a user expression authentication and services process in accordance with some embodiments of the disclosure; and

FIGS. 6A and 6B form a flowchart illustrating another user expression authentication process in accordance with some embodiments of the disclosure.

### DETAILED DESCRIPTION

In general, and for the purpose of introducing concepts of novel embodiments described herein, provided are systems and methods for interpreting biometric data captured during a transaction to determine user expression, and providing one or more services based on the interpretation. More particularly, embodiments relate to interpreting user expression based on biometric data captured from a user's device during a transaction, and then determining whether or not to authenticate the user, and in some embodiments also determining whether to provide targeted and/or value added services. For ease of understanding, embodiments are described herein with regard to payment transactions and/or financial transactions, however, those skilled in the art, upon reading this disclosure, will appreciate that the described user expression authentication services may be used with desirable results in other types of transactions that require user authentication, such as a user obtaining entry to a secure building or entry to a transportation hub such as a train station or bus station.

In some embodiments, biometric data captured by a user mobile device during a transaction is transmitted to an authentication service computer and then interpreted to determine the expression of the user. The user expression data may then trigger certain actions from one or more entities. For example, in an implementation if the user expression data is associated with fear and/or stress, then a fraud application is utilized to generate a risk score. When the risk score is below a predetermined threshold value then the user may be authenticated, but if it is above the threshold value then the authentication service computer may transmit a transaction declined message to the entity involved in the transaction with the user. Moreover, in some embodiments additional or other types of action(s) by one or more other entities may be triggered by user expression data indicating fear and/or stress. For example, an issuer financial institution (FI) may take one or more actions, such as having a customer service representative place a telephone call to the cardholder and/or a family member (who is registered with the issuer FI) to check on the user when the user expression data is associated with a fear and/or stress indication. In some implementations, when the authentication service computer determines that the user expression data (or biometric data) received from a user device indicates fear and/or stress then another prompt may be transmitted to that user device for the user to provide further biometric data and/or some other type of response or data.

In some embodiments, if the authentication service computer interprets the received biometric data (user expression data) as being associated with happiness and/or confidence, then the authentication service computer transmits a user authentication message to the entity involved in the transaction. In some implementations, the authentication service computer also checks to see if there are any transaction rules associated with that entity which should be followed with regard to the transaction. For example, if the entity involved in the transaction is a merchant then that merchant may have provided one or more transaction rules that direct the authentication service computer to transmit a coupon to the user's device when the user is authenticated and the user's expression data is interpreted to be equivalent to happiness or confidence. Such transaction rules may include, but are not limited to, directives to transmit other types of messages, benefits and/or offers to the user such as loyalty points, merchandise discounts and/or vouchers, marketing messages, cross-selling offers, targeted advertisements and the like. Accordingly, embodiments described herein provide improved user authentication systems and techniques and/or processes resulting in improved user experiences for both consumers and merchants, in particular when used in the context of purchase transactions involving user mobile devices. The systems and methods described herein also advantageously leverage existing payment processing network systems to provide improved user authentication, and solve the technological problem of how to provide electronic offers to users that are more likely to be accepted as compared to offers that are globally provided to each user involved in a particular type of transaction.

A number of terms will be used herein. The use of such terms are not intended to be limiting, but rather are used for convenience and ease of exposition. For example, as used herein, the term “user” may be used interchangeably with the term “consumer” and/or the with the term “cardholder” and these terms are used herein to refer to a person, individual, consumer, business or other organization that owns (or is authorized to use) a financial account such as a payment card account (such as a credit card account or debit card account) or some other type of account (such as a loyalty card account or mass transit access account). In addition, the term “payment card account” may include a credit card account, a debit card account, a loyalty card account and/or a deposit account or other type of financial account that an account holder or cardholder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and/or related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other entities or organizations (and thus are known as issuer financial institutions or issuer banks). In addition, the terms “payment system transaction data” and/or “payment network transaction data” or “payment card transaction data” or “payment card network transaction data” refer to transaction data associated with payment or purchase transactions that have been or are being processed over and/or by a payment network or payment system. For example, payment system transaction data may include a number of data records associated with individual payment transactions (or purchase transactions) of cardholders that have been processed over a payment card system or payment card network. In some embodiments, payment system transaction data may include information such as data that identifies a cardholder, data that identifies a cardholder's payment device and/or payment card account, transaction date and time data, transaction amount data, and an indication of the merchandise and/or services that have been purchased, and information identifying a merchant and/or a merchant category. Additional transaction details and/or transaction data may also be available and/or utilized for various purposes in some embodiments.

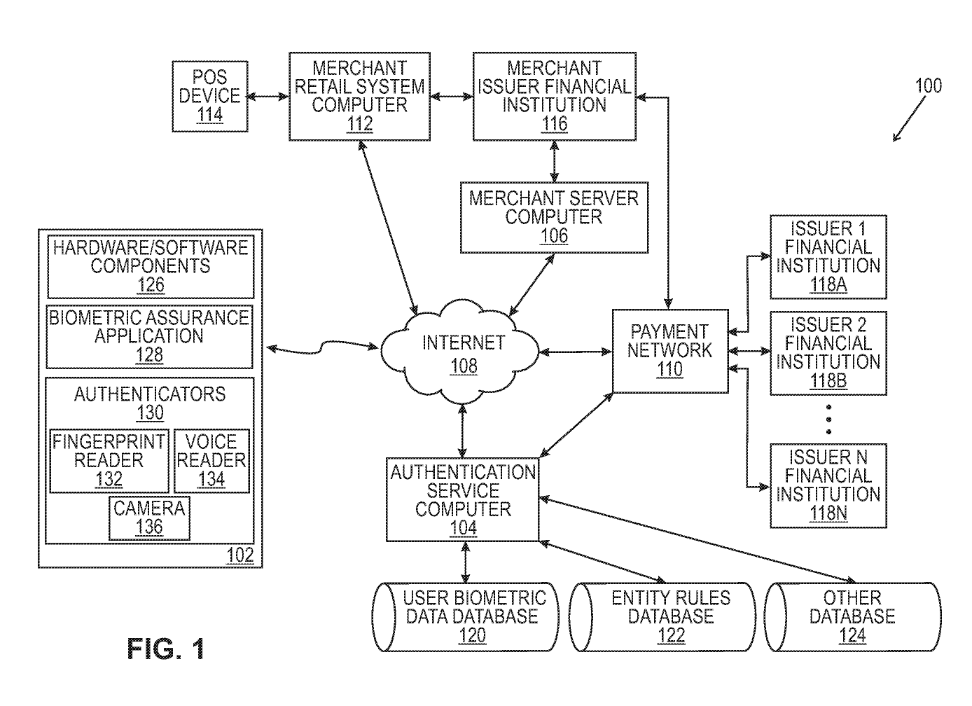

Features of some embodiments will now be described by reference to FIG. 1, which is a block diagram illustrating the components of a transaction system 100 pursuant to some embodiments. A transaction system pursuant to some embodiments involves a number of devices and entities interacting to conduct a transaction. For example, users may operate wireless mobile devices 102 to interact with an authentication service computer 104 and/or a merchant server computer 106 via the Internet 108 in accordance with the novel aspects described herein. In addition, in some implementations the authentication service computer 104 is configured to communicate with a payment network 110 and/or the merchant server computer 106 and/or the merchant retail system computer 112 via the Internet 108 in accordance with aspects described herein. Moreover, in some implementations the user may utilize his or her mobile device 102 to wirelessly communicate with a merchant's point-of-sale (POS) device 114 to conduct a purchase transaction. As shown, the POS device 114 is connected to the merchant retail system computer 112, which is operably connected to a merchant issuer financial institution (FI) computer 116, and the merchant issuer FI computer 116 may also be operably connected to the payment network 110. The payment network 110 is operably connected to a plurality of issuer FI computers 118, which hold customer financial accounts (such as consumer payment card accounts), including Issuer1 FI computer 118A, Issuer2 FI computer 118B to IssuerN FI computer 118N. In addition, the Authentication Service Computer 104 is shown operably connected to a user biometric database 120, entity rules database 122, and other database 124.

It should be understood that, while only a single mobile device 102, single merchant server computer 106, single payment network 110, single merchant retail system computer 112, and a single authentication service computer 104 are shown in FIG. 1, in practice a large number of such devices and/or components may be involved in a system in accordance with the novel aspects disclosed herein. Thus, the various blocks shown in FIG. 1 may include or be comprised of one or more computers, computer networks, and/or computer systems. Furthermore, although the various components of the transaction system 100 are shown connected via the Internet 108 for communications purposes, the components of a suitable transaction system may instead be configured for communication with each other via other types of networks and/or network connections, including proprietary and/or secure network connections.

Referring again to FIG. 1, the user mobile device 102 may be a smart phone, tablet computer, digital music player, laptop computer, smart watch, personal digital assistant (PDA), or the like, which includes hardware and/or software components that can be configured provide functionality and/or operations in accordance with the characteristics of that particular type of mobile device in order to conduct transactions with entities, such as merchants (either in a retail location or online) and/or transportation providers. For example, if the user mobile device is a tablet computer, then as shown in FIG. 1, it may include hardware and software components 126 that may include, but are not limited to a touch screen display, a microphone, a speaker, a digital camera, controller circuitry, an antenna, a memory or storage device, and software stored in a storage device and configured to provide tablet computer functionality. Storage devices utilized in the devices and/or system components described herein may be composed of or be any type of non-transitory storage device that may store instructions and/or software code for causing one or more processors of such electronic user devices to function in accordance with the novel aspects disclosed herein.

The mobile device 102 of FIG. 1 may also include a number of logical and/or functional components (in addition to the normal components found in a mobile device), such as a biometric assurance application 128 (or other software and/or middleware components to provide the functionality) and authenticators 110 for performing various different types of authentication. Embodiments may also utilize secure push authentication technology and/or other techniques or technology compatible with the user mobile device to deliver an optimal user experience. Such authenticators may include one or more of a fingerprint reader 132, a voice reader 134, and/or a digital camera 136. For example, the digital camera 136 may be utilized in some circumstances to capture a photograph of the user's face to perform a facial recognition process or the like during a transaction. It should be understood that some user mobile devices 102 may include two or more of such authenticators 130 in different combinations (for example, a smartphone may include a voice reader 134 and a camera 136, but not a fingerprint reader 132, while other types of mobile devices may include all three of these devices). Moreover, some types of mobile devices may only include one type of authenticator, for example a microphone.

A user may utilize the mobile device 102 to communicate with the authentication service computer 104 in order to enroll or register in a biometric authentication service to perform an authentication process pursuant to the novel aspects described herein. The authentication service computer 104 thus includes components for use to store information associated with user devices and other system participants (such as, for example, information associated with entities such as merchants that wish to utilize the features of the novel systems and/or processes disclosed herein). In particular, the authentication service computer 104 may include components including an interface (not shown) that can be implemented as a Web service (which is a method of communicating between two electronic devices over a network) using, for example, a Simple Object Access Protocol (SOAP) and/or Representational State Transfer (REST) or other techniques. Thus, the interface may be a SOAP/REST interface which allows communication between mobile devices 102 and other entities and/or their devices.

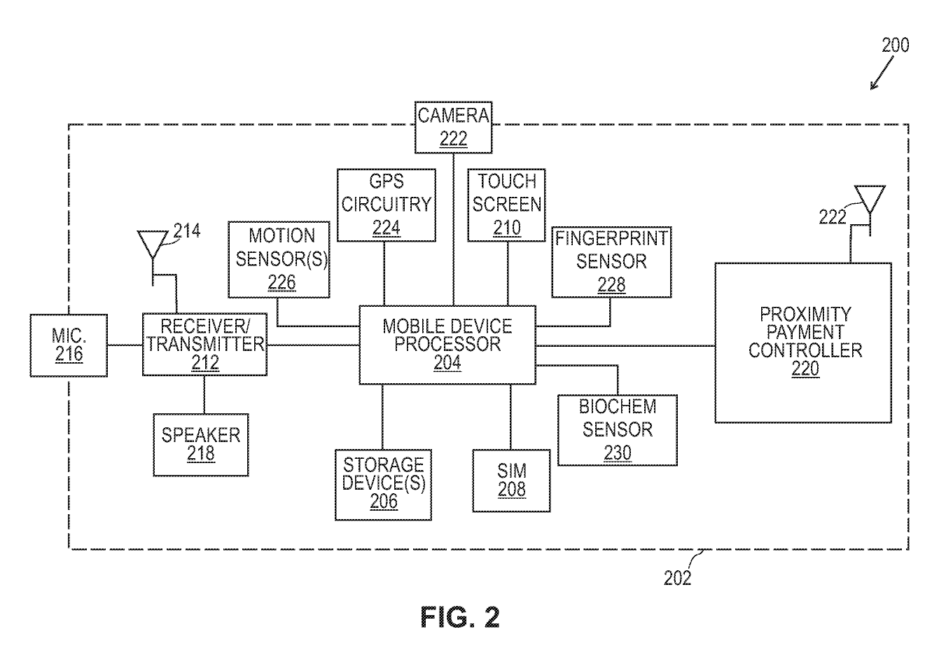

FIG. 2 is a block diagram of an embodiment of a user mobile device 200 illustrating hardware aspects that may be utilized to capture biometric data during a transaction and to transmit the biometric data to an authentication service computer for use in determining user expression for authenticating the user and for receiving one or more messages depending on the interpretation in accordance with some embodiments described herein. In this example, the user mobile device 200 is a mobile telephone or smartphone that is capable of conducting wireless transactions, and that may (but need not) have capabilities for functioning as a contactless payment device. In particular, the mobile device 200 may be a payment-enabled mobile telephone capable of online purchase transactions such as online purchase transactions, and may include hardware that is configured to provide novel functionality as described herein. In some other embodiments, however, novel functionality as described herein may result at least partially from novel software and/or middleware and/or firmware components that program or instruct one or more mobile device processors of the mobile device 200.

The mobile telephone 200 may include a conventional housing (indicated by dashed line 202) that contains and/or supports the other components of the mobile telephone. The mobile telephone 200 includes a mobile device processor 204 for controlling over-all operation, for example, it may be suitably programmed to allow the mobile telephone to engage in data communications and/or text messaging with other wireless devices and/or electronic devices, and to allow for interaction with web pages accessed via browser software over the Internet, as described herein. Other components of the mobile telephone 200, which are in communication with and/or are controlled by the mobile device processor 204, include one or more storage devices 206 (for example, program memory devices and/or working memory and/or secure storage devices, and the like), a subscriber identification module (SIM) card 208, and a touch screen display 210 for displaying information and/or for receiving user input.

The mobile telephone 200 also includes receive/transmit circuitry 212 that is also in communication with and/or controlled by the mobile device processor 204. The receive/transmit circuitry 212 is operably coupled to an antenna 214 and provides the communication channel(s) by which the mobile telephone 200 communicates via a mobile network (not shown). The mobile telephone 200 further includes a microphone 216 operably coupled to the receive/transmit circuitry 212, which the microphone 216 is operable to receive voice input from the user. In addition, a loudspeaker 218 is also operably coupled to the receive/transmit circuitry 212 and provides sound output to the user.

The mobile telephone 200 may also include a proximity payment controller 220 which may be a specially designed integrated circuit (IC) or chipset. The proximity payment controller 220 may be a specially designed microprocessor that is operably connected to an antenna 222 and may function to interact with a Radio Frequency Identification (RFID) and/or Near Field Communication (NFC) proximity reader (not shown), which may be associated, for example, with a Point-of-Sale (POS) terminal of a merchant. For example, the proximity payment controller 220 may provide information and/or data, such as a user's payment card account number, when the user is using the mobile device 200 to conduct a purchase transaction to pay for merchandise, for example, by communicating with a POS terminal of a merchant in a retail store location.

The user's mobile device 200 may include one or more sensors and/or circuitry that functions to provide and/or obtain user identification data and/or user authentication data from the user. For example, the user mobile device may be a Smartphone including one or more components and/or authenticators such as an integrated camera 222, a microphone 216, global positioning sensor (GPS) circuitry 224, one or more motion sensors 226, a fingerprint sensor 228 and/or a biochemical sensor 230 that are operably connected to the mobile device processor 204. One or more additional types of biometric components (not shown), such as heart rate sensors and/or heart rate monitors, blood pressure sensors iris and/or retina detectors, oxygen sensors, glucose and/or blood sugar sensors, pedometers and/or speed sensors, body temperature sensors, and the like, could also be utilized to provide biometric data for use to interpret the expression or mood of the user in accordance with the processes described herein.

In some embodiments, the authenticators can be used to perform other tasks in addition to obtaining data for user authentication purposes, such as mobile device identification data. For example, the integrated camera 222 functions normally to take digital pictures, and may also be operable to read two-dimensional (2D) and/or three-dimensional (3D) barcodes to obtain information. Moreover, the camera may be configured as a thermal imaging device, a digital camera and/or a webcam to capture video images. For example, the camera may be used to take a picture of the user's face (and/or of other relevant portions of the user and/or of the immediate environment) so as to discern the expression and/or mood of the user in accordance with processes described herein. In addition, the microphone 216 may be utilized by a user, for example, during a user biometric authentication service enrollment process (discussed in more detail below) wherein user voice print data is obtained and then stored in relation to different types of user expressions and/or emotions such as fear, stress, happiness and/or confidence. In yet another example, a heart rate sensor may be utilized to capture the user's heart rate during a transaction and analyzed against pre-stored values to determine or interpret the mood and/or physical state of the user, such as in a state of excitement and/or stress and/or calmness and/or a neutral state. In some other embodiments, such biometric data of a user could be analyzed in real time in order to formulate an interpretation regarding the state and/or expression of the user. For example, biometric data associated with the user's heartbeat could be analyzed in real time during a transaction to make a determination regarding whether or not the user is calm and/or at rest, or whether that biometric data indicates excitement and/or stress.

Referring again to FIG. 2, the GPS circuitry 224 may be operable to generate information concerning the location of the user and/or user mobile telephone 200. In addition, the motion sensor(s) 226 may be operable to generate motion data, for example, that may be transmitted to the authentication service computer 104 for processing during a transaction and used to authenticate a user. For example, data may be generated that can be used to identify the user's walking style or gait. In another example, the motion sensor(s) 226 may operate to generate force data associated with, for example, the force generated by the user's finger when he or she touches the touch screen 210. If the force generated by the user's finger is interpreted as being “heavy” or “violent” then the authentication service computer 104 may tentatively interpret the user expression as being one of fear or anger.

Referring again to FIG. 2, the fingerprint sensor 228 may include a touch pad or other component (not shown) for use by the user to touch or swipe his or her index finger when fingerprint data is required to identify the user in order to conduct a transaction (such as provide entry to a building). The biochemical sensor 230 may include one or more components and/or sensors operable to obtain user biological data, such as breath data and/or saliva from the user for analysis. Other types of biological data could be obtained as well, which may be analyzed in some embodiments by the authentication service computer during a transaction to determine a user expression for authentication and/or for determining additional services purposes.

In some embodiments, the data obtained by the motion sensor(s) 226, fingerprint sensor 228 and/or biochemical sensor 230, may be transmitted from the user's mobile device 200 to the authentication service computer 104 (See FIG. 1), which may be a cloud-based computer system, for enrollment purposes and/or for analysis to authenticate the user and/or determine whether or not to provide additional services. For example, the authentication service computer may compare received biometric data and/or other user data to user data stored, for example, in a user biometric database accessible. In addition, in some embodiments, the mobile device processor 204 and receiver/transmitter circuitry 212 may be operable to transmit cardholder data and/or user financial transaction data and/or user mobile device data to the authentication service computer for authentication processing. The mobile device processor 204 may also utilize the receiver/transmitter circuitry 212 to transmit GPS data, for example, to one or more entities (such as a merchant computer and/or an issuer financial institution computer) regarding the current location of the user mobile device. The user mobile device 200 may also contain one or more other types of sensors, such as an iris scanner device (not shown) or other biometric sensor(s) capable of generating iris scan data of a user's eye, which may be useful for identifying biometric or other personal data of the mobile device user.

It should also be understood that, in some implementations, more than one form of user identification data and/or user biometric data may be required to authenticate a user and/or to provide additional services when certain types of transactions occur. For example, if a consumer is attempting to utilize a mobile device to purchase an expensive item from an online merchant (for example, a wristwatch valued at more than one thousand dollars) then several different types of user biometric data may be required by the authentication service computer in accordance with one or more merchant business rules in order to authenticate the user. In such cases, several different types of biometric data may be required, for example, fingerprint data, photographic data representing the user's face to permit facial recognition processing, global positioning service (GPS) data, to securely authenticate the user before the purchase transaction is presented for purchase transaction authorization processing.

In addition, it should also be understood that in some implementations, the user's mobile device 200 may include software and/or instructions configured for causing the mobile device processor 204 to interpret some or all of the data obtained from one or more of the authenticators with regard to user expression. In such cases, the mobile device processor may also be configured to transmit that user expression interpretation data to the authentication service computer for further authentication processing and/or to perform other functions and/or to take action(s) based thereon in accordance with the processes described herein. For example, the motion sensor(s) 226 may provide force data to the mobile device processor associated with, for example, the force generated by the user's finger when he or she touches the touch screen 210. Instead of operating to transmit the raw data from the motions sensor(s) to the authentication service computer, in some implementations the mobile device processor interprets the force data as being a “heavy” or “violent” force generated by the user's finger and determines that it is equivalent to a user expression of fear or anger. User expression data indicating fear or anger is then transmitted as to the authentication service computer 104 for authentication processing and/or for use in determining further actions. Thus, the authentication service computer may utilize such received user expression data from the user's mobile device to authenticate the user, and/or as an input for authenticating the user (along with other data, for example), and/or as an input for making a determination as to whether or not further action should be taken (such as requesting further biometric data from the user, and/or generating a message for transmission to a customer service representative to call the user when the interpreted emotion is one of fear or anger, and/or transmitting).

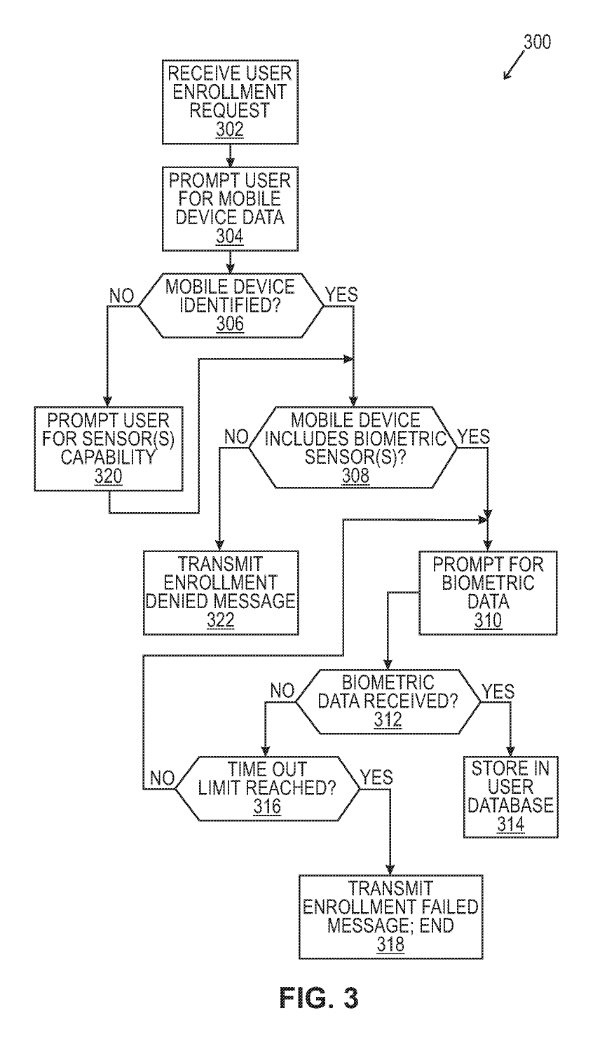

In some embodiments, users or consumers or cardholders may be required to enroll or register with the authentication service computer system before being permitted to participate in the user biometric authentication service in accordance with methods described herein. Thus, FIG. 3 illustrates a user enrollment process 300 according to some embodiments. In particular, an authentication service computer receives 302 a user enrollment request from a user device, which may be a mobile device as explained above. The enrollment request may include user identification data, such as the user's name and residence address, a cardholder account number, and an e-mail address. In some embodiments, the authentication service computer may prompt 304 the user to provide user mobile device identification data, such as the mobile device type and/or the name of the model device and/or a serial number. The authentication service computer may then attempt to identify 306 the mobile device based on the provided mobile device identification data, for example, by checking a database containing mobile device type information. If the mobile device is identified, then the authentication service computer determines 308 if the mobile device includes one or more biometric components and/or biometric sensor(s). If so, then the authentication service computer prompts 310 the user to provide biometric data based on the capabilities of the user's device.

In some embodiments, the user may be prompted to provide biometric data for each type of biometric sensor and/or component supported by the user's mobile device. For example, if the user's mobile device includes a camera and a microphone, then the user may be prompted to take a picture of his or her face (for facial recognition purposes) and to say one or more sentences in a particular manner. For example, the authentication service computer may prompt the user to make a face associated with anger (angry face) while taking a picture using the digital camera of the angry face, and to recite a sentence in an angry voice into the microphone. The photograph of the user's face and the voice data of the angry recitation are transmitted to the authentication service computer which stores the angry face picture and angry voiceprint data in a user biometric database in association with other user identification data for that user. The same process may be repeated for other emotions such as happy, sad, fearful, confident, stressed and/or neutral, and may be limited only by the type(s) of biometric components and/or sensors associated with the user's device. In another example, if the user's device also included a heart rate monitor, then he or she may be prompted to provide heartbeat data while at rest (indicating calmness) and heartbeat data while exercising (which may indicate stress). Such heartbeat data or pulse rate data can then be associated with corresponding user expressions and/or moods and/or biometric state and saved or stored in a user database for future reference when a transaction occurs.

Referring again to FIG. 3, if in step 312 the biometric data is not received with in predetermined amount of time (typically in the range of about 15-30 seconds), and a time-out limit 316 has not been reached (typically in the range of about 30-90 seconds), then the user is again prompted 310 to provide the biometric data. However, if the required user biometric data again is not provided in step 312 and the time out limit is reached, then in some embodiments the authentication service computer transmits 318 an enrollment failed message to the user's mobile device and the process ends.

Referring again to step 306, if the authentication service computer cannot identify the user's mobile device, then the user is prompted 320 to provide information concerning the biometric sensor(s) capabilities of his or her mobile device. If biometric sensors are available in step 308, then the authentication service computer prompts 310 the user for biometric data and the process continues as explained above. However, if in step 308 it is determined that the user's mobile device does not contain any biometric sensors, then the authentication service computer transmits 322 an enrollment denied message stating that the user device is ineligible for use with the authentication service because it does not contain any biometric sensors. However, in some implementations, a user may be denied enrollment if his or her user device contains only one type of biometric sensor, such as a microphone or digital camera.

Thus, a user may follow a process flow such as that illustrated by FIG. 3 to register or enroll by providing user biometric data that may include one or more different types of biometric data items. For example, a user may utilize his or her user mobile device to capture voice data (i.e., a voice print), and/or facial data, and/or other types of biometric data which then can be uploaded to the authentication service computer. Other types of user biometric data that can be utilized to authenticate the user includes, but is not limited to pulse data (i.e., heartbeat data), gait data (i.e., walking style data), iris scan data, and/or the like. Such user biometric data can then be stored in a user database associated with and accessible by the authentication service computer and then utilized to perform user authentication processing on behalf of a plurality of different types of entities and for a wide variety of different types of transactions and/or applications.

In some embodiments, a biometric application may be resident on the user's mobile device for receiving the authentication request from the authentication service computer and then displays a message on a screen for the user to perform a biometric authentication process. Thus, one or more biometric authenticators (such as a microphone, digital camera, breath sensor, heart rate sensor (or pulse rate sensor) and the like) obtains one or more biometric samples from the user, and then the user device transmits the biometric data in response to the authentication request message to the authentication service computer for further processing as described herein. However, as mentioned above, in some implementations, the user's mobile device may instead be configured to obtain biometric data and determine or generate user expression data (with regard to the data obtained from at least some of the biometric sensor components) for transmission to the authentication service computer for processing.

It should also be understood that, in some embodiments, users or consumers or cardholders who do not enroll or register or who do not fully enroll or register with the authentication service computer system may still be permitted to participate in the user biometric authentication service in accordance with methods described herein. In such cases, user biometric sample data is not available (i.e., because either a user has not enrolled or registered or has not provided certain types of biometric data), then the authentication service computer may be configured to compare biometric user data captured during a transaction with an “average” or “expected” biometric value which may be associated with an “average person” or “similar user” or the like. For example, heartbeat data captured by a user's mobile device and transmitted to the authentication service computer indicating a heartbeat of 80 beats per minute may be compared to heartbeat ranges for a “normal” person of the same approximate age of the user to make a determination regarding whether or not the user is calm or in an excited state. The authentication service computer may then utilize that determination as in input when interpreting all of the provided user biometric data to determine that the user expression indicates “anger” or “calmness” or “excitement” and the like.

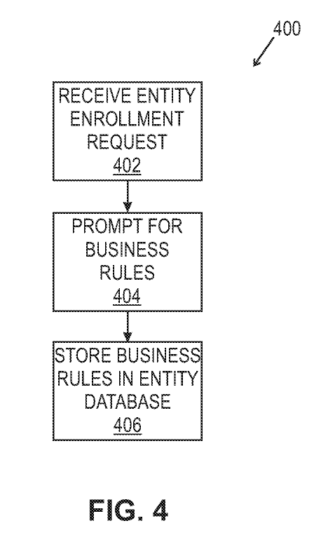

FIG. 4 is a flowchart illustrating an entity enrollment process 400 in accordance with some embodiments. In particular, an authentication service computer receives 402 an entity enrollment request, for example, from an entity device such as a merchant server computer hosting a merchant website or a merchant retail system computer. The enrollment request may include entity identification data, such as the name of the entity, entity business address data associated with one or more stores, website identification data, and entity contact information. The authentication service computer may then prompt 404 the entity computer for one or more business rules and/or policies of the entity that are to be utilized when conducting transactions with users. For example, the entity may institute one or more business rules for consumers shopping online who have accessed the entity's website to purchase merchandise. Upon receipt, the authentication service computer stores 406 the business rules data and/or policy data in, for example, an entity database. The business rules data and/or policy data may also be stored along with user identification data and the user biometric data for use when the authentication service computer authenticates a user during a transaction. When the user is authenticated, then the authentication service computer may utilize the business rules of the entity (along with any policy considerations) to determine if, for example, one or more messages and/or offers and/or coupons and/or loyalty points should be transmitted to the user device. In another example, when an interpretation of user biometric data indicates stress and/or fear, a business rule may indicate that an issuer financial institution be notified so that a customer service representative can attempt to contact the user and/or a relative of the user before authentication proceeds. Other types of business rules and/or policies can also be followed, which may depend on the entity involved in the transaction and/or the type of transaction.

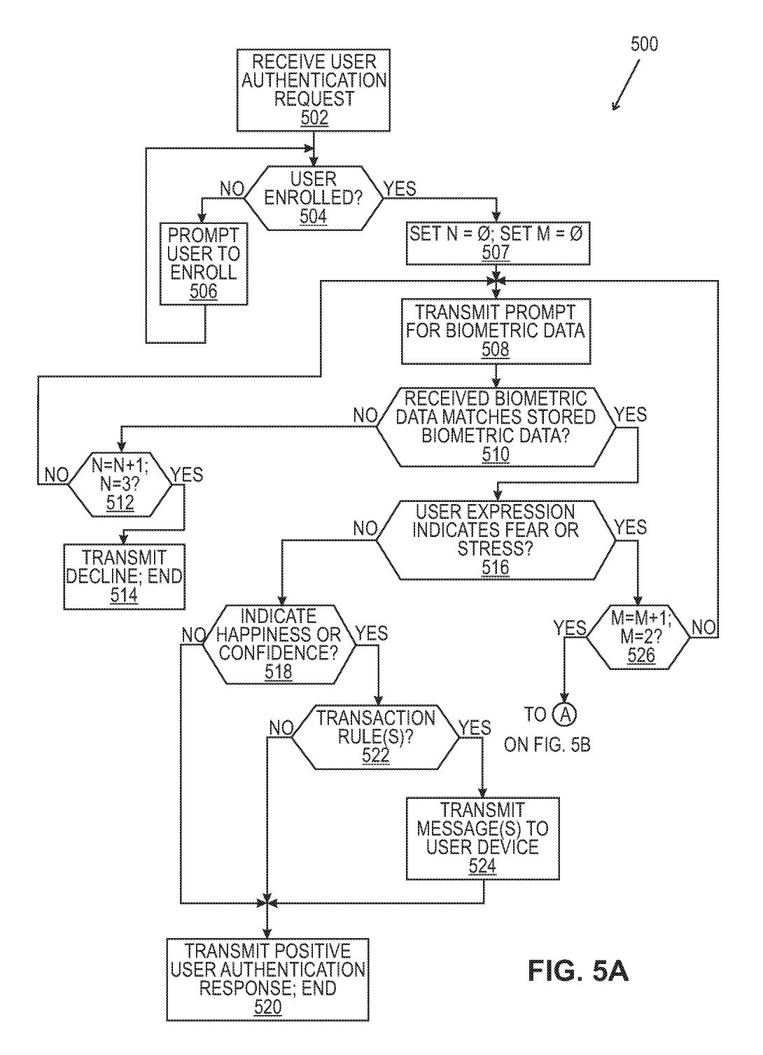

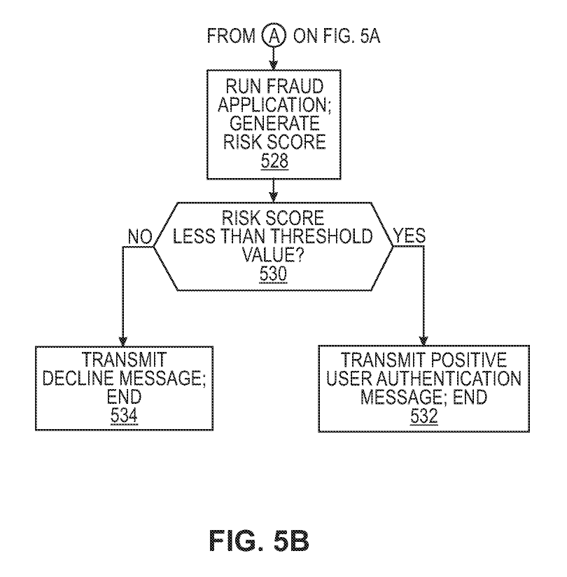

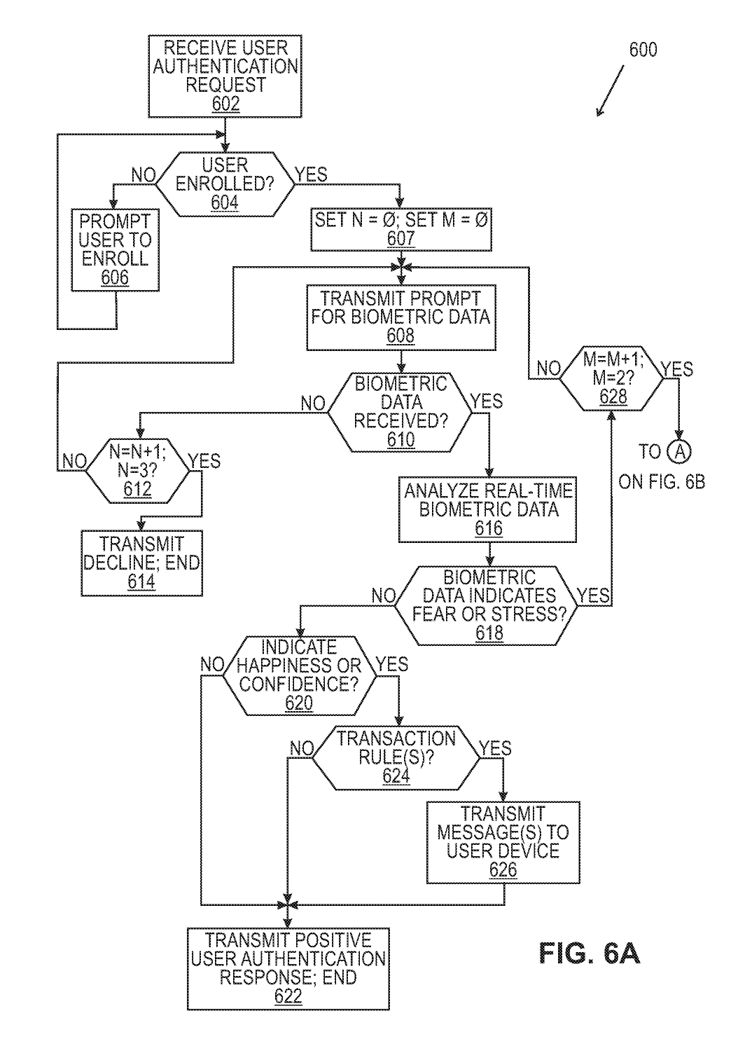

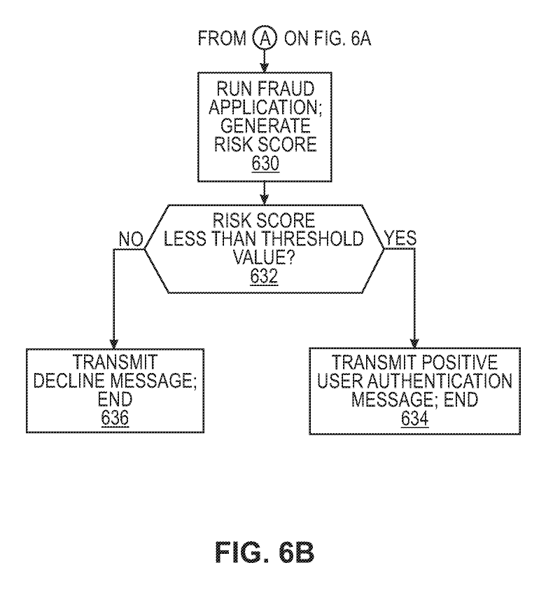

FIGS. 5A and 5B form a flowchart illustrating a user expression authentication process 500 in accordance with some embodiments. The authentication service computer receives 502 a user authentication request during a transaction, which may originate from a user mobile device or from an entity computer. The user authentication request may include transaction data, user identification data of the user involved in the transaction, and entity identification data (such as merchant data). The authentication service computer then determines 504, based on the user identification data, whether or not the user is enrolled in the user expression authentication service. For example, the user identification data is checked to see if it matches enrollment data stored in a user registration database or the like. If the user is not enrolled, then the authentication service computer transmits 506 a prompt message for the user to enroll, and the process illustrated in FIG. 3 may then be followed to register the user for the user expression authentication service. In some implementations, if the user does not respond to the prompt to enroll within a predetermined amount of time, then the authentication service computer transmits an authentication denied message to the user device and/or the entity computer (not shown). However, in some other embodiments, if the user is not enrolled (or is enrolled but has not provided biometric data), then the authentication service computer analyzes the biometric provided by the user in real time to determine a user expression, which alternate method is discussed further below with regard to FIGS. 6A and 6B.

Referring again to FIG. 5A, if the authentication service computer determines 504 that the user is enrolled, then the authentication service computer sets 507 “N” equal to zero and sets “M” equal to zero (N=0; M=0) and then transmits 508 a prompt message to the user device for the user to submit biometric data using at least one component of the user device.

The authentication service computer then determines 510 whether or not the received biometric data from the user device matches user biometric data that may be stored in a database. If a match is not found, then in some implementations the authentication service computer increments 512 a counter N by one and then again transmits a prompt 508 for the user to again generate and transmit user biometric data by using his or her device and transmit that to the authentication service computer. In some embodiments, the process includes prompting the user three times for the biometric data, and if a match does not occur such that N equals three (the third attempt) then the authentication service computer transmits 514 an authentication decline message to the user device and the process ends. It should be understood that although the example process described herein utilizes three attempts to prompt the user for biometric data, other contemplated implementations may utilized more or less such attempts before transmitting the authentication decline message (in the case where the user fails to provide the required biometric data).

However, if the authentication service computer determines 510 that the received biometric data from the user device matches stored user biometric data, then the authentication service computer determines 516, based on the matched biometric data, if the user expression indicates at least one of fear or stress. If not, then the authentication service computer determines 518, based on the matched biometric data, whether or not the user expression indicates at least one of happiness or confidence. If not, then the authentication service computer transmits 520 a positive user authentication response message, which may be sent to an entity computer of an entity (such as a merchant) involved in the transaction with the user. However, if the authentication service computer determines 518 that the user expression does indicate at least one of happiness or confidence, then the authentication service computer checks 522 to see if there are any transaction rules associated with that type of transaction and/or with the entity involved in the transaction. If so, then the authentication service computer transmits 524 one or more messages to the user device in accordance with transaction rule(s) which may have been pre-established by the entity involved in the transaction, and next transmits 622 the positive user authentication response message, for example, to an entity computer of an entity (such as a merchant) involved in the transaction with the user. As mentioned above, the message(s) transmitted to the user device in accordance with one or more transaction rules may include, but are not limited to, coupons, loyalty points, discount offers, upgrade offers, upsell offers and the like.

Referring again to FIG. 5A, if the authentication service computer determines 516, based on a match of received biometric data with stored biometric data, that the user expression does indicate at least one of fear or stress, then in some implementations the authentication service computer sets 517 “M” equal to zero (M=0) and then increments 525 a counter M by one and the process loops back so that the user is again prompted 508 to submit and transmit user biometric data. As shown, in some embodiments when the user expression indicates fear or stress the process includes prompting the user twice for the biometric data, and if the indication continues to be that the expression is one of fear or stress then the process continues in FIG. 5B wherein the authentication service computer runs 528 a fraud application and generates a risk score. It should be understood that, in some other embodiments wherein fear or stress is indicated, instead of (or in addition to) prompting the user again for biometric data the user authentication computer may transmit (not shown) a message to the entity computer or to a customer service representative so that an agent can attempt to contact the user in real time in order to discern what is happening during the transaction. For example, the authentication service computer may transmit an alert message to a customer service telephone representative that a cardholder has exhibited signs of stress or fear during a transaction, and that customer service representative may then attempt to call or message the user on his or her cell phone in real time in an attempt to check on the circumstances of the transaction. In such cases, the user authentication process may be suspended until such time that the customer service representative confirms that the transaction and/or the authentication process should continue.

Referring again to FIG. 5B, after the authentication service computer generates 528 the risk score, the authentication service computer next determines 530 whether or not the risk score is less than a predetermined threshold value. If so, then the authentication service computer transmits 532 a positive user authentication response to the entity involved in the transaction, and the process ends. However, if the risk score is greater than or equal to a predetermined threshold value then the authentication service computer transmits 534 a transaction decline message to the entity involved in the transaction, and the process ends. Thus, the authentication service computer transmits a positive user authentication response to the entity involved in the transaction when the at least one type of user expression comprises at least one of happiness and confidence, and when the risk score is less than a predetermined threshold value.

FIGS. 6A and 6B form a flowchart illustrating another user expression authentication process 600 in accordance with some embodiments. The authentication service computer receives 602 a user authentication request during a transaction, which may originate, for example, from a user mobile device or from an entity computer. The user authentication request may include transaction data, user identification data of the user involved in the transaction, and entity identification data (such as merchant data). The authentication service computer then determines 604, based on the user identification data, whether or not the user is enrolled in the user expression authentication service. For example, the user identification data is checked to see if it matches enrollment data stored in a user registration database or the like. If the user is not enrolled, then the authentication service computer transmits 606 a prompt message for the user to enroll, and the process illustrated in FIG. 3 may then be followed to register the user for the user expression authentication service. In some implementations, if the user does not respond to the prompt to enroll within a predetermined amount of time, then the authentication service computer transmits an authentication denied message to the user device (not shown) and/or entity computer.

Referring again to FIG. 6A, if the authentication service computer determines 604 that the user is enrolled, then the authentication service computer sets 607 “N” equal to zero and sets “M” equal to zero (N=0; M=0) and then transmits 608 a prompt message to the user device for the user to submit biometric data using at least one component (such as a biometric sensor) of the user device. The authentication service computer then determines 610 whether or not the biometric data was received within a predetermined period of time (which correlates to biometric data provided by the user in real-time). If the biometric data is not received within the predetermined period of time then, in some implementations, the authentication service computer increments 612 a counter “N” by one and then again transmits a prompt 608 for the user to again generate and provide user biometric data by using his or her device to transmit the required data to the authentication service computer. In some embodiments, the process includes prompting the user three (3) times for the biometric data, and if a match does not occur such that N equals three (the third attempt) then the authentication service computer transmits 614 an authentication decline message to the user device and/or the entity computer and the process ends. It should be understood that although the example process described herein utilizes three attempts to prompt the user for biometric data, other contemplated implementations may utilized more or less such attempts before transmitting the authentication decline message (in the case where the user fails to provide the required biometric data).

However, if the authentication service computer determines 610 that the required biometric data has been received from the user device, then the authentication service computer analyzes 616 the real-time biometric data and determines 618 if the user expression is one or both of fear or stress. For example, the authentication service computer may receive heartbeat data and/or user facial data and make a determination based on one or more factors that the user's heartbeat is elevated and that the facial data associates with a scowl or frown to thus indicate anger and/or fear and/or stress. If fear and/or stress is not indicated, then the authentication service computer determines 620 if the received biometric data indicates a user expression that correlates to at least one of happiness or confidence. If not, then the authentication service computer transmits 622 a positive user authentication response message, which may be sent to an entity computer of an entity (such as a merchant) involved in the transaction with the user. However, if the authentication service computer determines 620 that the user expression does correlate with or indicate at least one of happiness or confidence, then the authentication service computer checks 624 to see if there are any transaction rules associated with that type of transaction and/or with the entity involved in the transaction. If so, then the authentication service computer transmits 626 one or more messages to the user device in accordance with transaction rule(s) which may have been pre-established by the entity involved in the transaction, and next transmits 622 a positive user authentication response message, which may be sent to an entity computer of an entity (such as a merchant) involved in the transaction with the user. As mentioned above, the message(s) transmitted to the user device in accordance with one or more transaction rules may include, but are not limited to, coupons, loyalty points, discount offers, upgrade offers, upsell offers and the like.

Referring again to FIG. 6A, if the authentication service computer determines 618 that the user expression does indicate at least one of fear or stress, then in some embodiments the authentication service computer increments 628 the counter “M” by one and the process loops back so that the user is again prompted 608 to provide user biometric data (transmitted from the user's device to the authentication service computer). In the example embodiment shown, when the user expression indicates fear or stress the process includes prompting the user twice for biometric data, and if the determination continues to be that the user expression is one of fear or stress then the process continues in FIG. 6B wherein the authentication service computer runs 630 a fraud application and generates a risk score. As mentioned above, in some embodiments wherein fear or stress is indicated, instead of (or in addition to) prompting the user again for biometric data the user authentication computer may transmit (not shown) a message to the entity computer or to a customer service representative so that an agent can attempt to contact the user in real time in order to discern what is happening during the transaction. For example, the authentication service computer may transmit an alert message to a customer service telephone representative that a cardholder has exhibited signs of stress or fear or anger during a transaction, and that customer service representative may then attempt to call or message the user on his or her cell phone in real time in an attempt to check on the circumstances of the transaction. In such cases, the user authentication process may be suspended until such time that the customer service representative confirms that the transaction and/or the user authentication process should continue.

Referring again to FIG. 6B, after the authentication service computer generates 630 the risk score, the authentication service computer next determines 632 whether or not the risk score is less than a predetermined threshold value. If so, then the authentication service computer transmits 634 a positive user authentication response to the entity involved in the transaction, and the process ends. However, if the risk score is greater than or equal to a predetermined threshold value then the authentication service computer transmits 636 a transaction decline message to the entity involved in the transaction, and the process ends. Thus, the authentication service computer transmits a positive user authentication response to the entity involved in the transaction when the at least one type of user expression comprises at least one of happiness and confidence, and when the risk score is less than a predetermined threshold value.

Accordingly, the authentication service computer first determines the user expression based on user biometric data that is provided by the user in real time during a transaction. Advantageously, the transaction system including the authentication service computer can support various forms of transactions such as point-of-sale (POS) transactions at a merchant retail location, unattended terminal transactions, and e-commerce (card not present) transactions. In embodiments described herein, if the user expression correlates to fear and/or stress and/or anger, then the authentication service computer runs a fraud application to generate a risk score. In some implementations, the fraud application utilizes criteria provided by, for example, an issuer financial institution (which entity may have provided the user with a payment card account that is being used in the transaction, for example) to generate the risk score. However, in some other implementations, the fraud application may utilize criteria provided by another type of entity involved in the particular transaction with the user.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for authenticating a user based on user expression, comprising:
receiving, by an authentication service computer, a user authentication request during a transaction, the user authentication request comprising transaction data, user identification data, and entity identification data;
determining, by the authentication service computer based on the user identification data, that the user is enrolled in a user expression authentication service;
transmitting, by the authentication service computer to a user device of the user, a prompt message for biometric data;
determining, by the authentication service computer, that biometric data received from the user device matches stored biometric data associated with the user indicating at least one type of user expression;
generating, by the authentication service computer, a risk score when the at least one type of user expression comprises at least one of fear and stress;
transmitting, by the authentication service computer to an entity computer associated with the entity identification data, a positive user authentication response when one of:
the risk score is less than a predetermined threshold value, or
the at least one type of user expression comprises at least one of happiness and confidence; and
transmitting, by the authentication service computer to the entity computer, a transaction decline message when the risk score exceeds the predetermined threshold value.

2. The method of claim 1, further comprising, when the at least one type of user expression comprises at least one of happiness and confidence:
determining, by the authentication service computer, that at least one transaction rule associated with the entity applies to the transaction; and
transmitting, by the authentication service computer, at least one message to the user device in accordance with the at least one transaction rule.

3. The method of claim 1, wherein the authentication service computer receives the user authentication request from one of a merchant device, a merchant financial institution (FI) computer, a merchant retail system computer, or a user device.

4. The method of claim 1, wherein transmitting the prompt message for biometric data further comprises:
determining, by the authentication service computer, that the user device comprises at least two types of biometric authenticators; and
generating, by the authentication service computer, a prompt message requesting biometric data from the at least two types of biometric authenticators.

5. The method of claim 1, wherein the authentication request message further comprises user device identification data.

6. The method of claim 1, further comprising, subsequent to transmitting the prompt message for biometric data to the user's device:
determining, by the authentication service computer, that biometric data received from the user device does not match stored biometric data associated with the user;
incrementing, by the authentication service computer, a counter; and
transmitting, by the authentication service computer, another prompt message for biometric data to the user's device.

7. The method of claim 6, further comprising, subsequent to incrementing the counter:
determining, by the authentication service computer, that the value of the counter equals a predetermined threshold value; and
transmitting, by the authentication service computer, a decline message to at least one of the user's device and the entity computer.

8. A system for interpreting user expression, comprising:
an authentication service computer;
a payment network operably connected to the authentication service computer;
a user mobile device configured for communications with the payment network and the authentication service computer; and
a merchant computer operably connected to the authentication service computer;
wherein the authentication service computer includes at least one storage device storing instructions configured to cause the authentication service computer to:
receive a user authentication request during a transaction, the user authentication request comprising transaction data, user identification data of a user, and entity identification data;
determine based on the user identification data that the user is enrolled in a user expression authentication service;
transmit a prompt message to a user device of the user to submit biometric data;
determine that biometric data received from the user device matches stored biometric data associated with the user indicating at least one type of user expression;
generate a risk score when the at least one type of user expression comprises at least one of fear and stress;
transmit to an entity computer associated with the entity identification data, a positive user authentication response when one of:
the risk score is less than a predetermined threshold value, or
the at least one type of user expression comprises at least one of happiness and confidence; and
transmit a transaction decline message to the entity computer when the risk score exceeds the predetermined threshold value.

9. The system of claim 8, wherein the at least one storage device stores instructions configured to, when the at least one type of user expression comprises at least one of happiness and confidence, cause the authentication service computer to:
determine that at least one transaction rule associated with the entity applies to the transaction; and
transmit at least one message to the user mobile device in accordance with the at least one transaction rule.

10. The system of claim 8, wherein the instructions stored in the storage device for transmitting the prompt message for biometric data are configured to cause the authentication service computer to:
determine that the user device comprises at least two types of biometric authenticators; and
generate a prompt message requesting biometric data from the at least two types of biometric authenticators.

11. The system of claim 8, further comprising instructions stored in the storage device, subsequent to the instructions for transmitting the prompt message for biometric data, configured to cause the authentication service computer to:
determine that biometric data received from the user device does not match stored biometric data associated with the user;
increment a counter; and
transmit another prompt message for biometric data to the user's device.

12. The system of claim 11, further comprising instructions stored in the storage device, subsequent to the instructions for incrementing the counter, configured to cause the authentication service computer to:
determine that the value of the counter equals a predetermined threshold value; and
transmit a decline message to at least one of the user's device and the entity computer.

13. A method for authenticating a user based on user expression, comprising:
receiving, by an authentication service computer, a user authentication request during a transaction, the user authentication request comprising transaction data, user identification data, and entity identification data;
determining, by the authentication service computer based on the user identification data, that the user is enrolled in a user expression authentication service;
transmitting, by the authentication service computer to a user device of the user, a prompt message for biometric data;
receiving, by the authentication service computer, the biometric data within a predetermined amount of time;
determining, by the authentication service computer, that the biometric data received from the user device indicates at least one of fear and stress;
generating, by the authentication service computer, a risk score;
transmitting, by the authentication service computer to an entity computer associated with the entity identification data, a positive user authentication response when the risk score is less than a predetermined threshold value; and
transmitting, by the authentication service computer to the entity computer, a transaction decline message when the risk score exceeds the predetermined threshold value.

14. The method of claim 13, further comprising, subsequent to receiving the biometric data within a predetermined amount of time:
determining, by the authentication service computer, that the biometric data received from the user device indicates at least one of happiness and confidence;
determining, by the authentication service computer, that at least one transaction rule associated with the entity applies to the transaction; and
transmitting, by the authentication service computer, at least one message to the user device in accordance with the at least one transaction rule.

15. The method of claim 13, wherein the authentication service computer receives the user authentication request from one of a merchant device, a merchant financial institution (FI) computer, a merchant retail system computer, or a user device.

16. The method of claim 13, wherein transmitting the prompt message for biometric data further comprises:
determining, by the authentication service computer, that the user device comprises at least two types of biometric authenticators; and
generating, by the authentication service computer, a prompt message requesting biometric data from the at least two types of biometric authenticators.

17. The method of claim 13, wherein the authentication request message further comprises user device identification data.

18. A system for interpreting user expression, comprising:
an authentication service computer;
a payment network operably connected to the authentication service computer;
a user mobile device configured for communications with the payment network and the authentication service computer; and
a merchant computer operably connected to the authentication service computer;
wherein the authentication service computer includes at least one storage device storing instructions configured to cause the authentication service computer to:
receive a user authentication request during a transaction, the user authentication request comprising transaction data, user identification data, and entity identification data;
determine based on the user identification data, that the user is enrolled in a user expression authentication service;
transmit to a user device of the user, a prompt message for biometric data;
receive the biometric data within a predetermined amount of time;
determine that the biometric data received from the user device indicates at least one of fear and stress;
generate a risk score;
transmit a positive user authentication response to an entity computer associated with the entity identification data when the risk score is less than a predetermined threshold value; and
transmit a transaction decline message to the entity computer when the risk score exceeds the predetermined threshold value.

19. The system of claim 18, wherein the at least one storage device stores instructions configured to, subsequent to the instructions for receiving the biometric data within a predetermined amount of time, cause the authentication service computer to:
determine that the biometric data received from the user device indicates at least one of happiness and confidence;
determine that at least one transaction rule associated with the entity applies to the transaction; and
transmit at least one message to the user device in accordance with the at least one transaction rule.

20. The system of claim 18, wherein the instructions stored in the storage device for transmitting the prompt message for biometric data further comprise instructions configured to cause the authentication service computer to:
determine that the user device comprises at least two types of biometric authenticators; and
generate a prompt message requesting biometric data from the at least two types of biometric authenticators.

21. An authentication service computer enrollment process comprising:
receiving, by an authentication service computer from a mobile device of a user, a enrollment request message comprising user identification data;
processing, by the authentication service computer, the enrollment request message;
transmitting, by the authentication service computer, at least one prompt message to the user's mobile device for biometric data associated with at least one expression;
receiving, by the authentication service computer from the user device, the biometric data;
storing, by the authentication service computer, the biometric data associated with at least one expression in association with the user identification data; and
setting, by the authentication service computer, an On-Behalf-Of (OBO) service flag to “true” indicating at least one of that the user is enrolled in the biometric authentication service and that user biometric data is stored from the user device.

22. The method of claim 21, wherein receiving the authentication service enrollment request comprises communicating, by the authentication service computer, with a biometric authentication application operating on the user's device.

23. The method of claim 21, wherein the biometric authentication service enrollment request message comprises mobile device identification data.

24. The method of claim 23, further comprising, identifying, by the authentication service computer based on the mobile device identification data, at least one types of authenticator component available on the user's mobile device.
